(19) United States
(12) Patent Application Publication
(10) Pub. No.: US 2018/0013904 A1
(43) Pub. Date: Jan. 11, 2018

(54) IMAGE FORMING APPARATUS

(71) Applicant: KYOCERA Document Solutions Inc., Osaka (JP)

(72) Inventor: Tomohide Hozono, Osaka (JP)

(21) Appl. No.: 15/637,187

(22) Filed: Jun. 29, 2017

(30) Foreign Application Priority Data
Jul. 5, 2016 (JP) 2016-133410

(51) Int. Cl. H04N 1/00; B41J 3/46

(52) U.S. Cl. CPC H04N 1/00408; B41J 3/46; H04N 1/00405

(57) ABSTRACT

An image forming apparatus includes a main body unit, an operation unit, and a support unit. The main body unit has a first side surface and a second side surface that is opposite to the first side surface. The operation unit has an operation surface. The support unit is fixed to the main body unit and supports the operation unit in a state where a position of the operation unit can be changed between a first position and a second position such that the operation surface is directed to a first side surface side when the operation unit is in the first position, and is directed to a second side surface side when the operation unit is in the second position.

### INCORPORATION BY REFERENCE

This application is based upon and claims the benefit of priority from the corresponding Japanese Patent Application No. 2016-133410 filed on Jul. 5, 2016, the entire contents of which are incorporated herein by reference.

### BACKGROUND

The present disclosure relates to an image forming apparatus including an operation unit such as an operation panel.

An image forming apparatus, such as a copier, a printer, a facsimile apparatus, and a multifunction peripheral, has an operation panel that allows an operation to be input to the image forming apparatus. The operation panel may be provided with hark keys, a touch panel or the like.

In general, the operation panel is provided in an upper portion of a front surface of the image forming apparatus. There is known an image forming apparatus provided with an operation panel whose position can be changed so that even a user sitting on a wheelchair can easily operate the operation panel.

### SUMMARY

An image forming apparatus according to an aspect of the present disclosure includes a main body unit, an operation unit, and a support unit. The main body unit has a first side surface and a second side surface that is opposite to the first side surface. The operation unit has an operation surface. The support unit is fixed to the main body unit and supports the operation unit in a state where a position of the operation unit can be changed between a first position and a second position such that the operation surface is directed to a first side surface side when the operation unit is in the first position, and is directed to a second side surface side when the operation unit is in the second position.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective diagram showing an outer appearance of an image forming apparatus according to an embodiment of the present disclosure.

FIG. 2 is a schematic diagram showing a configuration of the image forming apparatus according to the embodiment of the present disclosure.

FIG. 3 is a side-view diagram showing an outer appearance of the image forming apparatus according to the embodiment of the present disclosure.

FIG. 4 is a side-view diagram showing an outer appearance of the image forming apparatus according to the embodiment of the present disclosure.

FIG. 5 is a perspective diagram showing an outer appearance of an upper portion of the image forming apparatus according to the embodiment of the present disclosure.

FIG. 6 a schematic diagram showing a configuration of an image forming apparatus according to a modification of the embodiment of the present disclosure.

FIG. 7 is a diagram showing a modification of a support unit included in the image forming apparatus according to the embodiment of the present disclosure.

FIG. 8 is a diagram showing another modification of the support unit included in the image forming apparatus according to the embodiment of the present disclosure.

### DETAILED DESCRIPTION

The following describes an embodiment of the present disclosure with reference to the accompanying drawings for the understanding of the present disclosure. It should be noted that the following embodiment is an example of a specific embodiment of the present disclosure and should not limit the technical scope of the present disclosure.

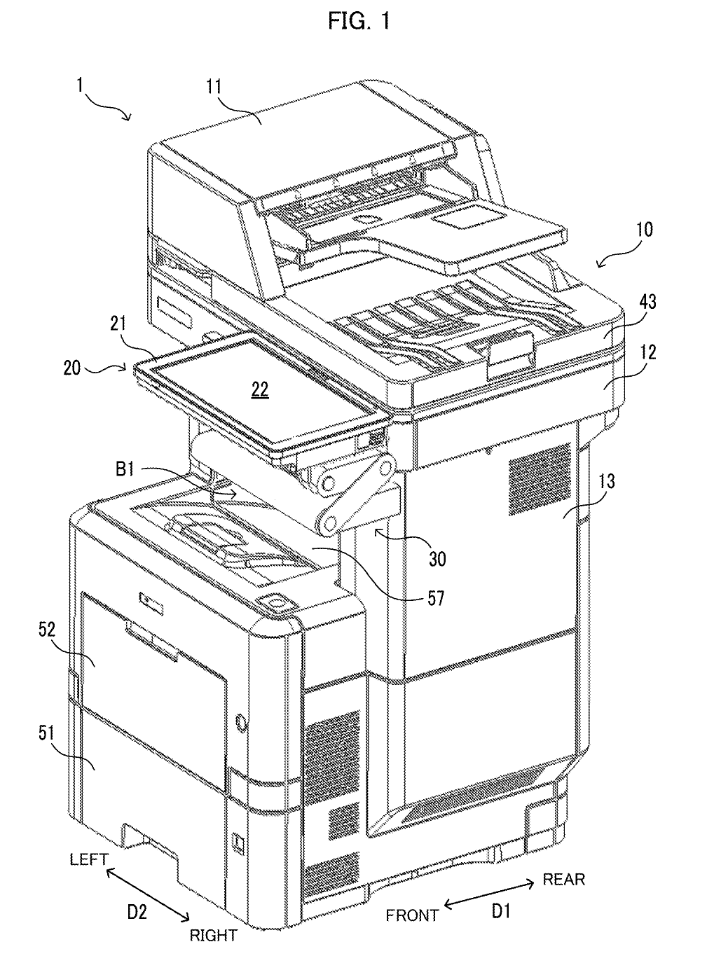

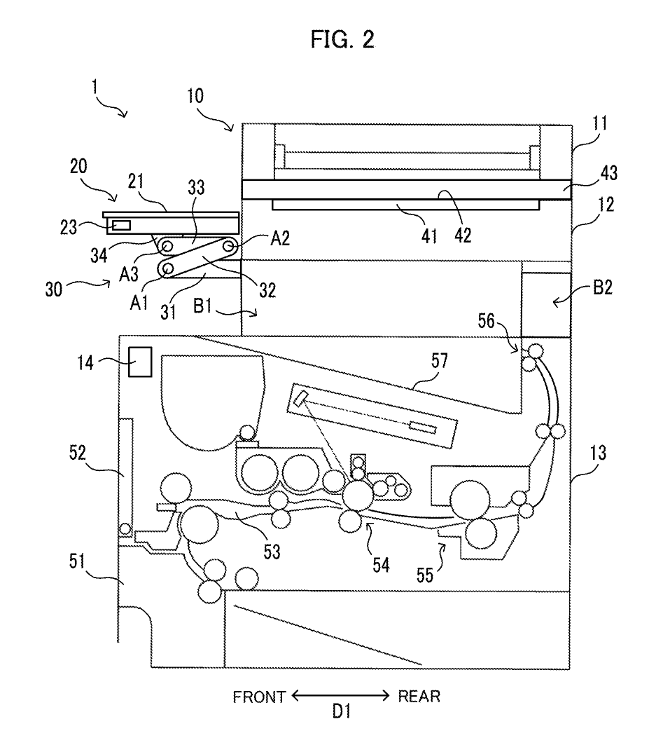

As shown in FIG. 1 and FIG. 2, an image forming apparatus 1 according to the embodiment of the present disclosure includes a main body unit 10, an operation unit 20, and a support unit 30. It is noted that in the following description, among four side surfaces of the main body unit 10 of the image forming apparatus 1, a front side surface (an example of the “first side surface” of the present disclosure) in a front-rear direction D1 is referred to as a “front” or a “front surface”, and a rear side surface (an example of the “second side surface” of the present disclosure) in the front-rear direction D1 is referred to as a “rear” or a “rear surface”. In addition, a right side surface in a left-right direction D2 is referred to as a “right surface”, and a left side surface in the left-right direction D2 is referred to as a “left surface”.

The main body unit 10 includes an ADF (Auto Document Feeder) 11, an image reading unit 12, an image forming unit 13, and a control unit 14. The image reading unit 12 reads an image of a document sheet by using a CCD (Charge Coupled Device) sensor (not shown), and generates image data representing the image of the document sheet. The image reading unit 12 reads an image from a document sheet placed on a document sheet placement surface 42 of a document sheet table 41 (see FIG. 2), and reads an image from each of document sheets fed one by one by the ADF 11. A document sheet cover unit 43 for covering the document sheet placement surface 42 is provided on the image reading unit 12. The document sheet cover unit 43 is provided on the main body unit 10 in a state where the document sheet cover unit 43 can be opened and closed by being pivoted around a pivot axis that intersects orthogonally with the front surface (or the rear surface) of the main body unit 10.

The image forming unit 13 executes an image forming process (printing process) of forming an image by the electrophotographic system based on image data read by the image reading unit 12, or based on image data input from an external information processing apparatus such as a personal computer. The image forming unit 13 includes a sheet feed cassette 51, a sheet feed tray 52, a conveyance path 53, an image creating unit 54, a fixing unit 55, a discharge port 56, and an in-body discharge portion 57 (an example of the “first discharge portion” of the present disclosure).

The sheet feed cassette 51 is provided in a state where it can be pulled out frontward in the front-rear direction D1 with respect to the main body unit 10. The sheet feed tray 52 is provided on the front side of the main body unit 10 so as to be opened and closed with respect to the main body unit 10. A sheet set in the sheet feed cassette 51 or the sheet feed tray 52 is conveyed along the conveyance path 53 by a plurality of rollers.

The image creating unit 54 includes a photoconductor drum, a charging device, a LSU (Laser Scanner Unit), a developing device, a transfer roller, a cleaning blade, and an electricity removing device. The image creating unit 54 transfers, onto a sheet, a toner image that corresponds to image data read by the image reading unit 12, or image data input from an external information processing apparatus such as a personal computer.

The fixing unit 55 applies heat and pressure to a sheet conveyed along the conveyance path 53 so that the toner image that has been transferred to the sheet by the image creating unit 54, is fixed to the sheet. The sheet with the toner image fixed thereto is conveyed to the discharge port 56 provided in a rear portion of the main body unit 10. Subsequently, the sheet is discharged from the discharge port 56 to the in-body discharge portion 57. The in-body discharge portion 57 is provided on an upper surface of the image forming unit 13, and the image reading unit 12 is located above the in-body discharge portion 57.

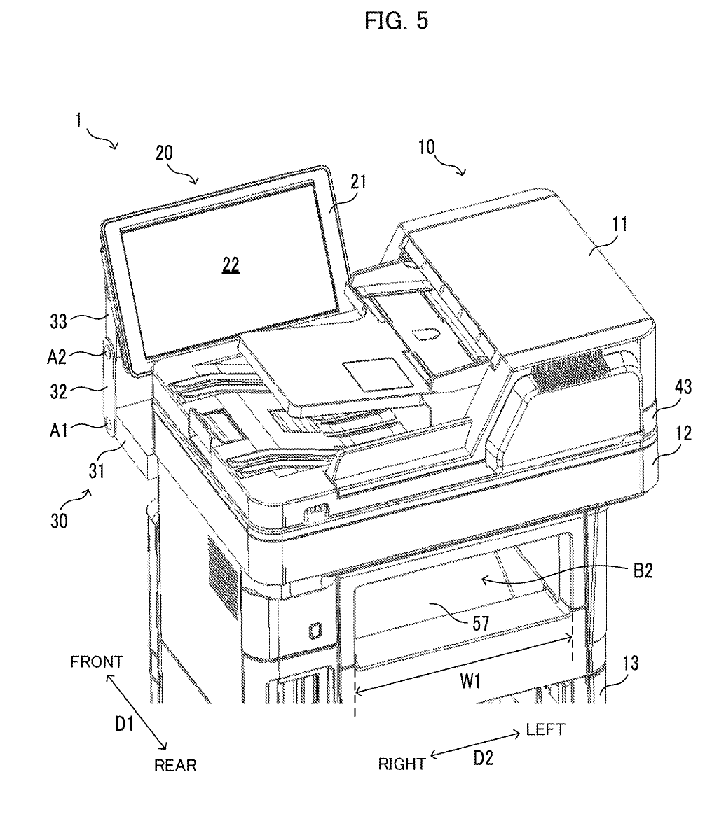

An opening portion B1 is provided in the front surface of the main body unit 10 so that a sheet placed on the in-body discharge portion 57 can be taken out from the front side. In addition, an opening portion B2 is provided in the rear surface of the main body unit 10 so that a sheet placed on the in-body discharge portion 57 can be taken out from its rear side (see FIG. 5). A width W1 of the opening portion B2 in the left-right direction D2 is preferably larger than the width of the sheet in the left-right direction D2.

The control unit 14 includes control equipment such as CPU, ROM, and RAM. The CPU is a processor that executes various calculation processes. The ROM is a nonvolatile storage portion in which various information such as control programs for causing the CPU to execute various processes are stored in advance. The RAM is a volatile or nonvolatile storage portion that is used as a temporary storage memory (working area) for the various processes executed by the CPU. The control unit 14 functions as a position detecting unit, a display control unit, and a conveyance control unit that are described below, based on the control programs stored in the ROM. The control unit 14 is an example of the “position detecting unit”, “display control unit”, and “conveyance control unit” of the present disclosure.

The operation unit 20 includes an operation surface 21. The operation surface 21 includes a touch panel display 22 (an example of the “display unit” of the present disclosure). On the touch panel display 22, various types of operation screens, such as a menu screen and a print setting screen, for operating the image forming apparatus 1 are displayed. The user can operate the image forming apparatus 1 by touching soft keys included in the various types of operation screens displayed on the touch panel display 22. It is noted that although in the present embodiment, the touch panel display 22 is included in the operation surface 21, but, as another embodiment, the operation surface 21 may include only a plurality of hard keys without the touch panel display 22. Furthermore, the operation surface 21 may include both the plurality of hard keys and the touch panel display 22.

Meanwhile, in a case where the image forming apparatus 1 is, for example, installed in the center of a room, not near a wall, it would be convenient if the image forming apparatus 1 could be operated from its rear side, as well as from its front side. However, a general image forming apparatus is designed based on an assumption that the image forming apparatus is operated from its front side. As a result, in a general image forming apparatus, the operation panel is not configured to be directed to the rear side, and it is difficult to operate the apparatus from its rear side. On the other hand, the support unit 30 described below is provided in the image forming apparatus 1 of the present embodiment so that the apparatus can be operated easily from both the front side and the rear side.

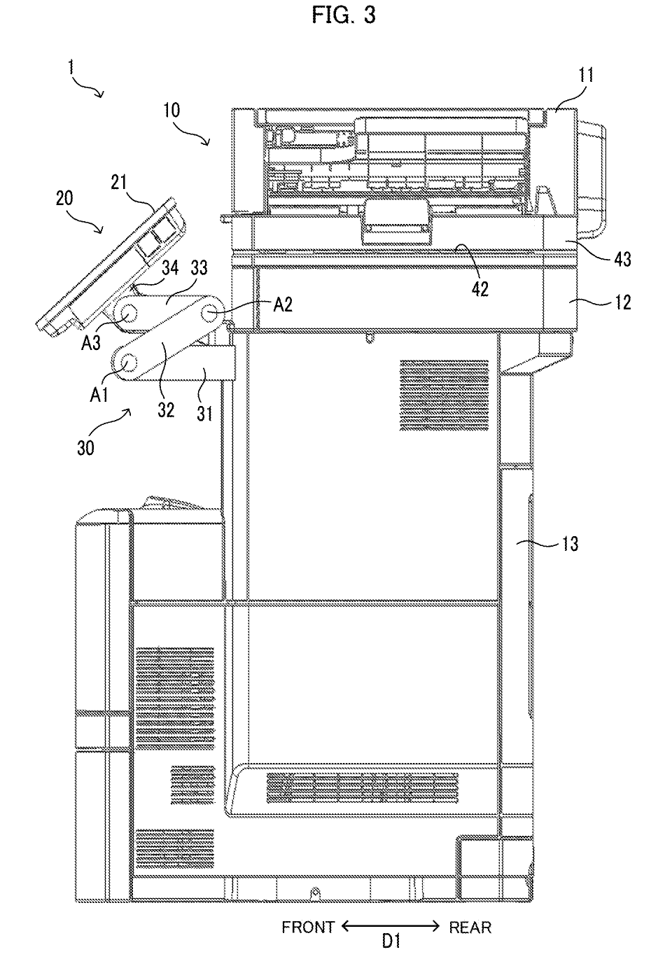

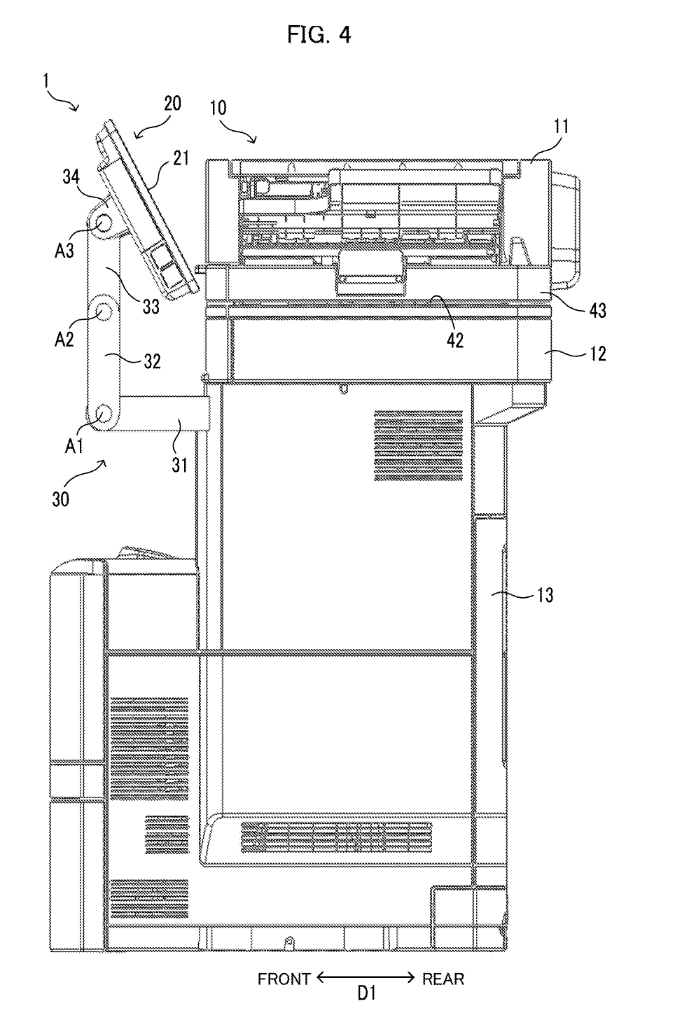

The support unit 30 is fixed to the front surface of the main body unit 10 and supports the operation unit 20. The support unit 30 supports the operation unit 20 in a state where a position of the operation unit 20 can be changed between a forward position (an example of the “first position” of the present disclosure) and a rearward position (an example of the “second position” of the present disclosure), wherein the operation surface 21 of the operation unit 20 is directed to the front side of the main body unit 10 when the operation unit 20 is in the forward position, and directed to the rear side of the main body unit 10 when the operation unit 20 is in the rearward position. FIG. 3 shows an example of the operation unit 20 being in the forward position, and FIG. 4 shows an example of the operation unit 20 being in the rearward position. For the operation of the image forming apparatus 1 from its front side, setting the position of the operation unit 20 to the forward position provides an easy operation. In addition, for the operation of the image forming apparatus 1 from its rear side, setting the position of the operation unit 20 to the rearward position provides an easy operation.

It is noted that the forward position is not limited to a state where the operation surface 21 of the operation unit 20 faces exactly the same direction as the front surface of the main body unit 10, but includes a state where the operation surface 21 is slightly inclined frontward with respect to its horizontal state (the state shown in FIG. 1 and FIG. 2). Similarly, the rearward position is not limited to a state where the operation surface 21 of the operation position 20 faces exactly the same direction as the rear surface of the main body unit 10, but includes a state where the operation surface 21 is slightly inclined rearward with respect to its horizontal state.

As shown in FIG. 2, the support unit 30 includes a support table 31, a first arm 32, a second arm 33, and a bracket 34.

The support table 31 is a plate-like member fixed to an upper portion of the front surface of the main body unit 10. A side surface of the base end of the support table 31 (a side surface thereof on the rear side in the front-rear direction D1) is fixed to the main body unit 10. A forward end of the support table 31 (the front side in the front-rear direction D1) is attached to one of opposite ends of the first arm 32 in a state where the first arm 32 can pivot around a pivot axis A1 that extends along the left-right direction D2. The other end of the first arm 32 is attached to one of opposite ends of the second arm 33 in a state where the second arm 33 can pivot around a pivot axis A2 that extends along the left-right direction D2. The other end of the second arm 33 is attached to the bracket 34 in a state where the bracket 34 can pivot around a pivot axis A3 that extends along the left-right direction D2. The operation unit 20 is fixed to the bracket 34.

The support unit 30 functions as a pivot mechanism that supports the operation unit 20 in a state where the operation unit 20 can pivot around a horizontal axis. For example, it is possible to pivot the operation unit 20 around the pivot axis A1 by changing the angle formed between the support table 31 and the first arm 32. In addition, it is possible to pivot the operation unit 20 around the pivot axis A2 by changing the angle formed between the first arm 32 and the second arm 33. Furthermore, it is possible to pivot the operation unit 20 around the pivot axis A3 by changing the angle formed between the second arm 33 and the bracket 34. With such a configuration of the pivot mechanism, it is possible to change the position of the operation unit 20 between the forward position and the rearward position, wherein the forward position provides an easy operation from the front side, and the rearward position provides an easy operation from the rear side.

The support unit 30 also functions as a lifting mechanism that supports the operation unit 20 in a state where the height of the operation unit 20 can be changed. The first arm 32 and the second arm 33 are connected with each other in a state where they can pivot around the pivot axis A2. As a result, for example, as shown in FIG. 3, when the first arm 32 and the second arm 33 are oriented near the horizontal direction, the position of the operation unit 20 becomes lower, and as shown in FIG. 4, when the first arm 32 and the second arm 33 are oriented near the vertical direction, the position of the operation unit 20 becomes higher. In a case where an operation is performed from the front side of the image forming apparatus 1, the operation unit 20 can be set to a height (an example of the “first height” of the present disclosure) that is lower than the document sheet placement surface 42 as shown in FIG. 2 so that the operation unit 20 does not obstruct the setting of a document sheet on the document sheet placement surface 42. In addition, in a case where an operation is performed from the rear side of the image forming apparatus 1, the operation unit 20 can be set to a height (an example of the “second height” of the present disclosure) that is higher than the document sheet placement surface 42 as shown in FIG. 4 and FIG. 5 so that the operation surface 21 can be easily touched.

It is noted that as shown in FIG. 2, the operation unit 20 includes an inclination sensor 23 that is configured to detect an inclination of the operation unit 20. The inclination sensor 23 is, for example, an acceleration sensor. The control unit 14, based on an output signal from the inclination sensor 23, detects whether the position of the operation unit 20 is the forward position or the rearward position. That is, the control unit 14 functions as the position detecting unit configured to detect the position of the operation unit 20.

When the operation unit 20 is in the forward position, the control unit 14 sets a display orientation of an image displayed on the touch panel display 22 to a predetermined display orientation (standard display orientation). On the other hand, when the position of the operation unit 20 is the rearward position, the control unit 14 rotates the image displayed on the touch panel display 22 by 180 degrees from the standard display orientation. That is, the control unit 14 functions as the display control unit configured to change the display orientation of the image displayed on the touch panel display 22 based on the position of the operation unit 20 detected by the position detecting unit.

When the position of the operation unit 20 changes from the forward position (FIG. 3) to the rearward position (FIG. 4), the image displayed on the touch panel display 22 is rotated by 180 degrees. This makes it possible for the user to operate the image forming apparatus 1 from its rear side by looking at the operation screen oriented in the same direction as operated from the front side.

As described above, according to the present embodiment, it is possible to change the position of the operation unit 20 between the forward position and the rearward position. This provides an easy operation of the image forming apparatus 1 from both its front side and its rear side.

In addition, according to the present embodiment, the document sheet cover unit 43 can be opened and closed by being pivoted around a pivot axis that intersects orthogonally with the front surface (or the rear surface) of the main body unit 10. This makes it possible to set the document sheet on the document sheet placement surface 42 easily even from the rear side of the apparatus.

Furthermore, according to the present embodiment, the opening portion B2 is provided in the rear surface of the main body unit 10 so that a sheet placed on the in-body discharge portion 57 can be taken out therefrom (see FIG. 5). This makes it possible for the user to easily take out the sheet placed on the in-body discharge portion 57 even from the rear side of the apparatus.

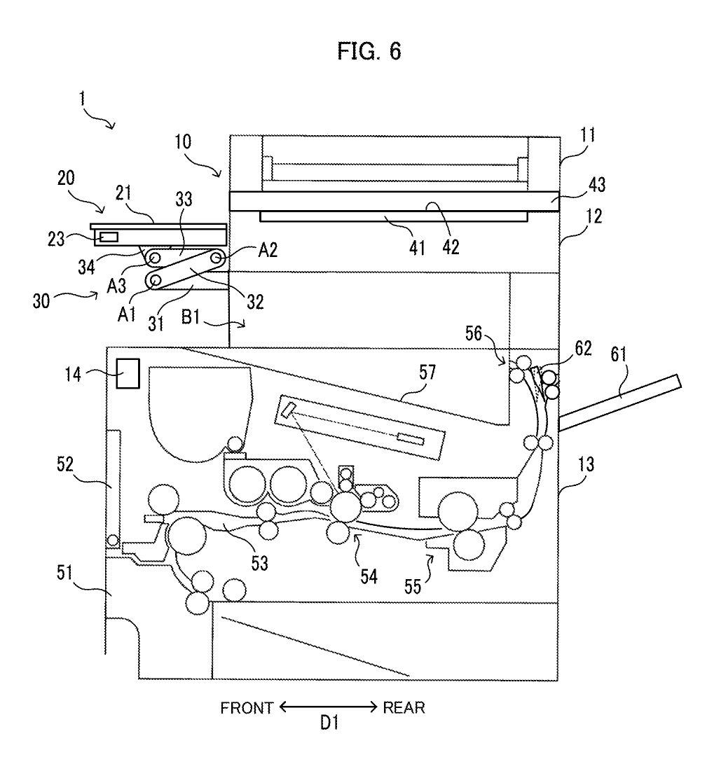

It is noted that in the present embodiment, the sheet is discharged to the in-body discharge portion 57, but, as another embodiment, as shown in FIG. 6, a discharge tray 61 (an example of the “second discharge portion” of the present disclosure) may be provided on the rear side of the main body unit 10. In that case, sheets discharged to the front side of the main body unit 10 are held by the in-body discharge portion 57, and sheets discharged to the rear side of the main body unit 10 are held by the discharge tray 61. When operating the image forming apparatus 1 from its rear side, the user can, via the operation unit 20, set the discharge destination of the sheet to the discharge tray 61. With this setting, the control unit 14 controls a switch member 62 so that sheets are discharged to the discharge tray 61. This makes it possible to take out discharged sheets easily from the rear side of the main body unit 10.

FIG. 6 shows a modification of the present embodiment. According to the modification, the control unit 14 automatically sets the discharge destination of the sheet based on the position of the operation unit 20, instead of the manual setting by the user of the discharge destination of the sheet. In this case, when the operation unit 20 is in the forward position, the control unit 14 sets the discharge destination of the sheet to the in-body discharge portion 57, and when the operation unit 20 is in the rearward position, the control unit 14 sets the discharge destination of the sheet to the discharge tray 61. That is, the control unit 14 functions as the conveyance control unit that causes the sheet to be discharged to the in-body discharge portion 57 when the position of the operation unit 20 detected by the position detecting unit is the forward position, and causes the sheet to be discharged to the discharge tray 61 when the position of the operation unit 20 detected by the position detecting unit is the rearward position. This eliminates the user's time and effort of manually setting the discharge destination of the sheet.

It is noted that although according to the present embodiment, the position detecting unit detects the position of the operation unit 20 based on the output signal from the inclination sensor 23, the present disclosure is not limited to this. As another embodiment, an angle sensor such as a potentiometer may be used to detect an angle between the support table 31 and the first arm 32, an angle between the first arm 32 and the second arm 33, and an angle between the second arm 33 and the bracket 34. The position detecting unit then may detect the position of the operation unit 20 based on these angles.

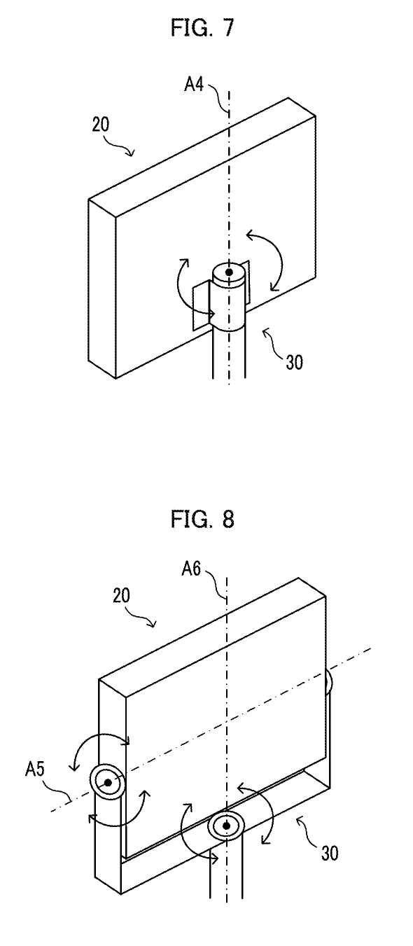

In addition, although according to the present embodiment, the operation unit 20 is supported so that it can pivot around a horizontal axis (the pivot axis A1, the pivot axis A2, or the pivot axis A3), but the present disclosure is not limited to this. As another embodiment, as shown in FIG. 7, the support unit 30 may include a pivot mechanism that supports the operation unit 20 so that the operation unit 20 can pivot around a vertical axis A4. As a further embodiment, as shown in FIG. 8, the support unit 30 may include a pivot mechanism (for example, a two-axis hinge) that supports the operation unit 20 so that the operation unit 20 can pivot around both a horizontal axis A5 and a vertical axis A6.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a main body unit having a first side surface and a second side surface that is opposite to the first side surface;
an operation unit having an operation surface; and
a support unit fixed to the main body unit and supporting the operation unit in a state where a position of the operation unit can be changed between a first position and a second position such that the operation surface is directed to a first side surface side when the operation unit is in the first position, and is directed to a second side surface side when the operation unit is in the second position.

2. The image forming apparatus according to claim 1, wherein
the support unit includes a pivot mechanism that supports the operation unit in a state where the support unit can pivot around at least one of a horizontal axis and a vertical axis

3. The image forming apparatus according to claim 1, wherein
the support unit includes a lifting mechanism that supports the operation unit in a state where a height of the operation unit can be changed.

4. The image forming apparatus according to claim 3, further comprising:
a document sheet table having a document sheet placement surface on which a document sheet is placed; and
an image reading unit configured to read an image from the document sheet placed on the document sheet placement surface, wherein
the lifting mechanism is configured to change the height of the operation unit between a first height that is lower than the document sheet placement surface, and a second height that is higher than the document sheet placement surface.

5. The image forming apparatus according to claim 3, wherein
the lifting mechanism includes a first arm and a second arm that are connected with each other in a state where the first arm and the second arm can pivot around a pivot axis.

6. The image forming apparatus according to claim 1, further comprising:
a display unit included in the operation surface;
a position detecting unit configured to detect a position of the operation unit; and
a display control unit configured to change a display orientation of an image displayed on the display unit based on the position of the operation unit detected by the position detecting unit.

7. The image forming apparatus according to claim 1, further comprising:
an in-body discharge portion on which discharged sheets are placed, wherein
an opening portion is provided in each of the first side surface and the second side surface such that the sheets placed on the in-body discharge portion can be taken out from the opening portion.

8. The image forming apparatus according to claim 1, further comprising:
a first discharge portion on which sheets discharged on the first side surface side are placed;
a second discharge portion on which sheets discharged on the second side surface side are placed;
a position detecting unit configured to detect a position of the operation unit; and
a conveyance control unit configured to cause a sheet to be discharged to the first discharge portion when the position of the operation unit detected by the position detecting unit is the first position, and cause a sheet to be discharged to the second discharge portion when the position of the operation unit detected by the position detecting unit is the second position.

9. The image forming apparatus according to claim 1, further comprising:
a document sheet cover unit provided on the main body unit in a state where the document sheet cover unit can be opened and closed by being pivoted around a pivot axis that intersects orthogonally with the first side surface.
